(19) United States
(12) Patent Application Publication
(10) Pub. No.: US 2026/0330498 A1
(43) Pub. Date: Oct. 22, 2026

(54) SYSTEMS AND METHODS FOR LARGE-SCALE CONTENT PERSONALIZATION

(71) Applicant: JPMORGAN CHASE BANK, N.A., New York, NY (US)

(72) Inventors: Arundeep CHINTA, Sunnyvale, CA (US); Smruthi MUKUND, San Jose, CA (US); Jay KATUKURI, Saratoga, CA (US); Ayush KARNAWAT, New York, NY (US)

(21) Appl. No.: 19/467,332

(22) Filed: Feb. 2, 2026

Related U.S. Application Data
(60) Provisional application No. 63/753,081, filed on Feb. 3, 2025.

(51) Int. Cl. G06Q 30/0242

(52) U.S. Cl. CPC G06Q 30/0244

(57) ABSTRACT

Systems and methods for large-scale content personalization are disclosed. According to an embodiment, a method may include: receiving, by a computer program, a feature vector comprising features derived from raw user data for a user and tile data for a plurality of tiles that are available to surface in a computer application; providing, by the computer program, the feature vector to an artificial neural network; receiving, from the artificial neural network and for each tile, an engagement probability parameter and an uncertainty parameter; receiving, by the computer program, a scaling factor that influences a randomness of the tiles being surfaced; ranking, by the computer program, the plurality of tiles using the engagement probability parameters, the uncertainty parameters, and the scaling factor; and controlling, by the computer program, the computer application to surface the plurality of tiles based on the ranking.

### RELATED APPLICATIONS

This application claims the benefit of, and priority to, U.S. Provisional Patent Application Ser. No. 63/753,081, filed Feb. 3, 2025, the disclosure of which is hereby incorporated, by reference, in its entirety.

### BACKGROUND OF THE INVENTION

### 1. Field of the Invention

Embodiments relate to systems and methods for large-scale content personalization.

### 2. Description of the Related Art

Large-scale content personalization faces two critical challenges: balancing exploration-exploitation and maintaining computational efficiency at scale. Traditional approaches like e-greedy exploration and Monte Carlo Dropout-based uncertainty estimation become impractical when serving millions of users with sub-100 ms latency requirements. This limitation is particularly acute in mobile applications, for financial services, where engagement directly impacts customer value. For example, a major banking application may have multiple content tiles and over 100 million daily users. Thus, it is difficult for the provider of a mobile application or similar to surface (or display) the most important content to each person while ensuring efficient exploration and minimizing computational overhead.

### SUMMARY OF THE INVENTION

Systems and methods for large-scale content personalization are disclosed. According to an embodiment, a method may include: receiving, by a computer program, a feature vector comprising features derived from raw user data for a user and tile data for a plurality of tiles that are available to surface in a computer application; providing, by the computer program, the feature vector to an artificial neural network; receiving, from the artificial neural network and for each tile, an engagement probability parameter and an uncertainty parameter; receiving, by the computer program, a scaling factor that influences a randomness of the tiles being surfaced; ranking, by the computer program, the plurality of tiles using the engagement probability parameters, the uncertainty parameters, and the scaling factor; and controlling, by the computer program, the computer application to surface the plurality of tiles based on the ranking.

In an embodiment, the tiles comprise blocks of information that are displayed within the computer application to promote a product or service.

In an embodiment, the artificial neural network may include a multi-layer perceptron that may be configured to extract the engagement probability parameter and the uncertainty parameter from the feature vector.

In an embodiment, tiles with limited interaction history are assigned a neutral engagement probability parameter and a high uncertainty parameter.

In an embodiment, higher ranked tiles are surfaced in a first viewport in the computer application.

According to another embodiment, a system may include: a user electronic device for user executing a computer application; and an electronic device in communication with the user data source and the tile library and executing a computer program that may be configured: to receive a feature vector comprising features derived from raw user data for a user and tile data for a plurality of tiles that are available to surface in the computer application; to provide feature vector to the artificial neural network; to receive, from the artificial neural network and for each tile, an engagement probability parameter and an uncertainty parameter; to receive a scaling factor that influences a randomness of the tiles being surfaced; to rank the plurality of tiles using the engagement probability parameters, the uncertainty parameters, and the scaling factor; and to control the computer application to surface the plurality of tiles based on the ranking.

In an embodiment, the tiles comprise blocks of information that are displayed within the computer application to promote a product or service.

In an embodiment, the artificial neural network may include a multi-layer perceptron that may be configured to extract the engagement probability parameter and the uncertainty parameter from the feature vector.

In an embodiment, tiles with limited interaction history are assigned a neutral engagement probability parameter and a high uncertainty parameter.

In an embodiment, higher ranked tiles are surfaced in a first viewport in the computer application.

According to another embodiment, a non-transitory computer readable storage medium may include instructions stored thereon, which when read and executed by one or more computer processors, cause the one or more computer processors to perform steps comprising: receiving a feature vector comprising features derived from raw user data for a user and tile data for a plurality of tiles that are available to surface in a computer application; providing the feature vector to an artificial neural network; receiving, for each tile, an engagement probability parameter and an uncertainty parameter; receiving a scaling factor that influences a randomness of the tiles being surfaced; ranking the plurality of tiles using the engagement probability parameters, the uncertainty parameters, and the scaling factor; and controlling the computer application to surface the plurality of tiles based on the ranking, wherein higher ranked tiles are surfaced in a first viewport in the computer application.

In an embodiment, the tiles comprise blocks of information that are displayed within the computer application to promote a product or service.

In an embodiment, the artificial neural network may include a multi-layer perceptron that may be configured to extract the engagement probability parameter and the uncertainty parameter from the feature vector.

In an embodiment, tiles with limited interaction history are assigned a neutral engagement probability parameter and a high uncertainty parameter.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for large-scale content personalization according to an embodiment;

FIG. 2 illustrates a method for large-scale content personalization according to an embodiment; and

FIG. 3 depicts an exemplary computing system for implementing aspects of the present disclosure.

### DETAILED DESCRIPTION OF PREFERRED EMBODIMENTS

Systems and methods for large-scale content personalization are disclosed. In an embodiment, a feature generation process is disclosed in which data from a data source is received, features are identified, transformed, and a model is trained.

For example, a dataset may include tiles and user interactions with the tiles. As used herein, a tile may be a small block of information that may be displayed within a computer program or application to promote a specific product or service. For example, in a banking application, an “Open an Account” tile provides icons linking customers to landing pages that guide them through account opening steps.

Based on the description of each tile, content tile embeddings are generated and may be used as input features to a model, such as a ranking model. The embeddings may capture the semantic meaning of the tile's purpose and content. Combined with user features, session features, and user-tile interaction history, these embeddings enable the model to predict both engagement probability and uncertainty, which together determine the tile's ranked position for each user.

Although embodiments may be described in the context of tiles, it should be noted that embodiments may be used with products or services that may be presented to a user in any suitable interface.

Embodiments may eliminate the need for multiple forward passes through ensemble members; may achieve comparable uncertainty quality with significantly reduced computational overhead; may maintain theoretical guarantees while improving practical scalability; and may enable real-time serving for large-scale applications.

Embodiments may use direct variance prediction as uncertainty estimates for guiding exploration in content personalization. Unlike approaches that use variance heads solely for uncertainty quantification or require sampling-based methods (e.g., Monte Carlo (MC) Dropout) for exploration, direct variance predictions provide superior uncertainty estimates for exploration without additional computational overhead.

Embodiments provide a principled exploration strategy that directly connects variance predictions with product ranking through a tunable scaling factor (a).

Embodiments address the cold-start problem for new content tiles without requiring dedicated cold-start mechanisms. In general, new content tiles are masked during training due to their limited interaction history, meaning the model receives little to no direct supervision for these items. As a result, the variance (uncertainty) head learns to associate sparse or missing user-tile interaction features with higher uncertainty and a neutral engagement probability parameter value (i.e., a neutral predicted mean value), thereby automatically promoting their exploration through the variance-based ranking without requiring explicit cold-start logic or heuristic-based exploration rules. This provides a practical advantage for production systems with frequently changing content catalogs.

For example, during exploration, rankings may be sampled from a normal distribution, so higher uncertainty creates a wider spread of sampled scores, which allows cold-start tiles to randomly appear at the top or bottom across different sessions. This gives them opportunities to be explored without introducing systematic positional bias.

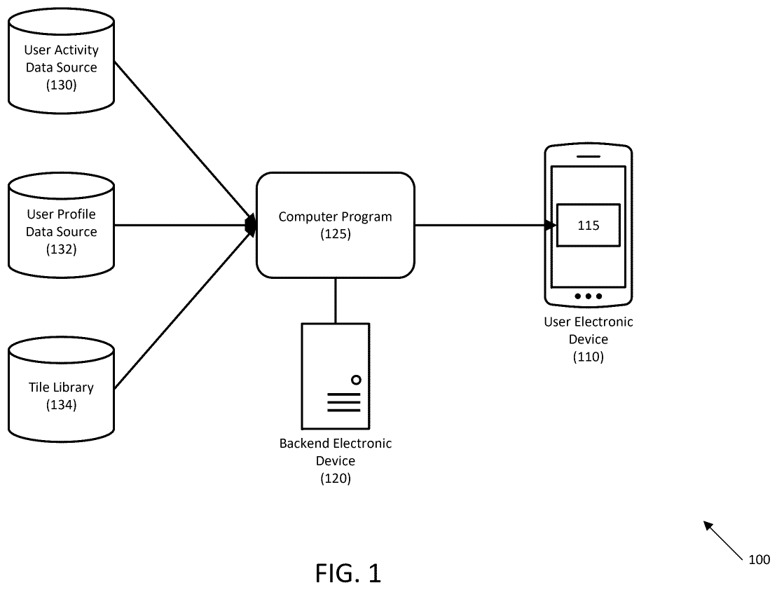

Referring to FIG. 1, a system for large-scale content personalization is disclosed according to an embodiment. System 100 may include user electronic device 110, which may be a computer, a mobile electronic device (e.g., a smart device), etc. User electronic device 110 may execute application 115 that may present tiles to a user during execution.

System 100 may include backend electronic device 120, which may be a server (e.g., physical and/or cloud-based), a computer (e.g., a workstation, a desktop, a laptop, a notebook, a tablet, etc.), a smart device (e.g., a smart phone, a smart watch, etc.), an Internet of Things (IoT) appliance, etc. In an embodiment, backend electronic device 120 may execute computer program 125 that may execute large-scale content personalization. For example, computer program 125 may receive historical user activity with application 115 from user activity data source 130, user profile information from user profile data source 132, and tile data for tiles from tile library 134 and may rank them for surfacing within application 115.

Historical user activity with application may include tiles that the user interacted with, tiles that were surfaced but were not interacted with, tiles that were not surfaced, landing page clicks, etc.

User profile information may include information on products held by the user, relationship indicators, payment behavior, etc.

Tile data may include, for example, content tile embeddings that may be generated from tile descriptions to capture semantic meaning, performance information (e.g., historical aggregate performance, such as overall click-through rates across users), etc.

In an embodiment, computer program 125 may use direct variance prediction to surface or present tiles within application 115.

In an embodiment, as new tiles are added to tile library 134, computer program 125 may assign each tile a predicted engagement probability parameter near 0.5 (neutral). This promotes the surfacing of these new tiles without requiring explicit cold-start logic or heuristic-based exploration rules.

In an embodiment, user electronic device 110 may execute computer program 125, and user activity data source may be device memory on user electronic device 110.

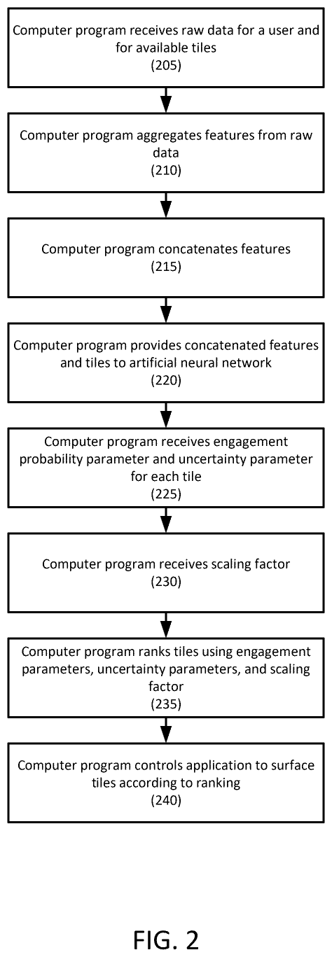

Referring to FIG. 2, a method for large-scale content personalization is disclosed according to an embodiment.

At 205, a computer program, such as a computer program executed by a backend electronic device, may receive raw data for a user and for available tiles. For example, the raw data may include historical data for user interaction with an application, such as a mobile application. The raw data may include historical interaction with tiles, such as whether the user interacted with the tile, landing page clicks, user product holdings and relationship indicators, temporal engagement patterns across multiple time windows, etc.

In an embodiment, the computer program may receive tile data from a plurality of users.

At 210, the computer program derives and aggregates features from the raw data, such as user interaction features, tile features, session features, and user profile features. User interaction features may identify, for example, temporal engagement pattens across multiple time windows, landing page click counts and interaction history, application starts, completions, and high intent actions.

Tile features may include content tile embeddings (e.g., generated from tile descriptions to capture semantic meaning and historical aggregate performance (e.g., overall click-through rates across users).

Session features may include historical activity patterns across recent sessions.

User profile features may include product holdings, relationship indicators, etc.

In an embodiment, the raw data may be first transformed into derived features through aggregation. For example, mobile interactions may be transformed into aggregated counts/statistics over time, landing page activity may be transformed into click counts and interaction history, funnel features may be transformed into aggregated counts for application starts, completions, high-intent actions, etc.

At 215, the computer program may concatenate the aggregated features into a single feature vector. For example, each feature group may be represented as a numerical vector, and all vectors may be concatenated into a single feature vector (e.g., a one-dimension array of real numbers).

At 220, the computer program may provide the concatenated feature vector to an artificial neural network, such as multilayer perceptron (MLPs) (e.g., single head or multi-head), Recurrent Neural Networks (RNNs), transformer networks, Graph Neural Networks (GNNs), etc. A MLP is a feedforward artificial neural network including at least three layers (e.g., input, hidden, output) of nodes, where each layer is fully connected to the next. It uses nonlinear activation functions and backpropagation training to solve complex, non-linearly separable problems.

As an example, a MLP may receive the concatenated feature vector (e.g., user, tile, session, interaction features), and may pass the input through several hidden layers that learn to extract relevant patterns and relationships from the features. Each layer may apply linear transformation (e.g., weights and biases), normalization (e.g., batch normalization), and non-linear activation (e.g., Parametric Rectified Linear Unit, or PRELU).

The output layer may split into two branches: a mean branch (u) that outputs, for each tile, an engagement probability parameter ut and a variance branch (σ²) the outputs, for each tile, an uncertainty parameter σₜ².

The mean branch may use sigmoid activation to constrain its output to [0, 1] that represents how likely the user is to select a tile. A higher value indicates a higher likelihood that the user will engage with the tile. Typical values range from approximately 0.2 to 0.8 across different tiles and users.

The variance branch may use a smooth, differentiable activation function, such as the Softplus activation function, to ensure positive values that represents how confident the model is in the prediction. A higher value indicates greater uncertainty (i.e., less confidence) in the corresponding engagement probability parameter. Based on empirical observations, typical values range from approximately 0.1 to 0.8, though tiles with limited interaction history (e.g., cold-start tiles) may exhibit higher uncertainty values.

The artificial neural network thus learns two things simultaneously—what it thinks will happen (mean) and how sure it is that it will happen (variance). The shared layers learn general patterns, while the final branches specialize in estimating these two different quantities from the same learned representation.

During training, the Gaussian NLL loss function may be used to jointly optimize mean predictions and uncertainty estimates, as defined below:

$$L ( μ , {σ}^{2} ) = \frac{1}{2} {\sum }_{i = 1}^{T} {w}_{t} ( {y}_{i} ) ( log ( max [ ϵ , {σ}^{2} ( {x}_{i} ) ] ) + \frac{{( {y}_{i} - μ ( {x}_{i} ) )}^{2}}{max ( ϵ , {σ}^{2} ( {x}_{i} ) )} )$$

wₜ(yᵢ) are tile-specific weights balancing positive/negative interactions. These may be calculated as the inverse of class frequency to handle the imbalance between rare click events (1) and more frequent non-click observations (0).

ϵ is a small positive constant preventing numerical instability, and is typically a small positive value (e.g., 10⁻⁶ or 10⁻⁸) for numerical stability). The value for e may be specified by the user.

In addition, T is the number of tiles, Yᵢ is the target label for tile i, μ(xᵢ) is the predicted mean for tile i, and σ²(xᵢ) is the predicted variance for tile i.

This equation includes an accuracy term ((yᵢ−μ(xᵢ))²) that penalizes predictions far from the true outcome and a confidence term (log (σ²)) that penalizes high variance (prevents the model from being uncertain about everything). The artificial neural network balances when predictions are accurate a lower variance is rewarded, and when predictions are wrong, a higher variance is less penalized (e.g., admits uncertainty). The artificial neural network cannot “cheat” by always predicting high variance due to the log term.

At 225, the computer program may receive the engagement probability parameter (μₜ) and the uncertainty parameter

$$( {σ}_{t}^{2} )$$

for each tile from the artificial neural network.

At 230, the computer program may receive a scaling factor (α) from, for example, an administrator. The scaling factor may influence the randomness of the tiles that are surfaced or displayed. Increasing the scaling factor enhances exploration and improves the guardrail metrics. If the scaling factor is too high, it introduces excessive randomness that overwhelms the model predictions, thereby adversely affecting the guardrail metrics.

Guardrail metrics are key performance indicators used to evaluate the impact of the personalization system on user experience and business outcomes. These metrics may include engagement metrics (e.g., overall click rate, clicks per user, engaged sessions per user, etc.), customer experience metrics (e.g., a customer satisfaction score), business outcome metrics (e.g., offers served, gross transaction value (normalized per user), mobile accounts opened per a certain number of users, digital accounts opened per a certain number of users, audience accounts per a certain number of users, digital account production across product lines, etc.). These guardrail metrics ensure that exploration-driven recommendations do not negatively impact user satisfaction or key business objectives while allowing the system to discover new user preferences.

At 235, the computer program may rank the tiles using the engagement probability parameters, uncertainty parameters, and the scaling factor. To do this, the computer program may first retrieve the engagement probability parameter (μₜ) and the uncertainty parameter

$$( {σ}_{t}^{2} )$$

for each tile from the artificial neural network.

Next, the computer program may sample from the prediction distributions for all tiles. For each tile, the prediction distribution is a Gaussian (normal) distribution defined by the engagement probability parameter (μₜ) as the mean and the scaled uncertainty parameter

$$( α \cdot {σ}_{t}^{2} )$$

as the variance. The computer program samples a score (sₜ) from this distribution for each tile. The sampled score represents a randomized engagement estimate that incorporates both the model's prediction and its uncertainty, enabling controlled exploration during ranking.

For example, the sample score (sₜ) for each tile may be calculated as follows:

$${s}_{t} ← 𝒩 ( {μ}_{t} , α \cdot {σ}_{t}^{2} )$$

For new tiles with limited interaction history, the neural network naturally outputs engagement probability parameters around 0.5 (reflecting uncertainty about engagement) with higher uncertainty parameters compared to tiles with established interaction history. This occurs during the forward pass through the neural network, before the sampling and sorting steps. The higher uncertainty parameter causes the sampled scores to vary more widely, allowing cold-start tiles to occasionally rank higher and be explored without introducing systematic positional bias.

Next, the computer program may sort the tiles based on the sample scores, resulting in a ranking of the tiles. In an embodiment, a tile with a higher ranking will be surfaced before a tile with a lower ranking. For example, the highest-ranked tiles may appear in the first viewport (immediately visible to the user), while lower-ranked tiles may require scrolling to view. Because user engagement drops significantly for tiles that require scrolling, the ranking prioritizes placing the most relevant tiles in the most visible positions.

At 240, the computer program may control the application to surface the tiles according to the ranking. In an embodiment, the ranking may be pre-computed in batch mode (e.g., daily) and stored in a database or cache. When a user accesses the application, the application retrieves the stored ranking for that user and displays the tiles in the order specified by the ranking, with higher-ranked tiles appearing in more prominent positions.

Hereinafter, general aspects of implementation of the systems and methods of embodiments will be described.

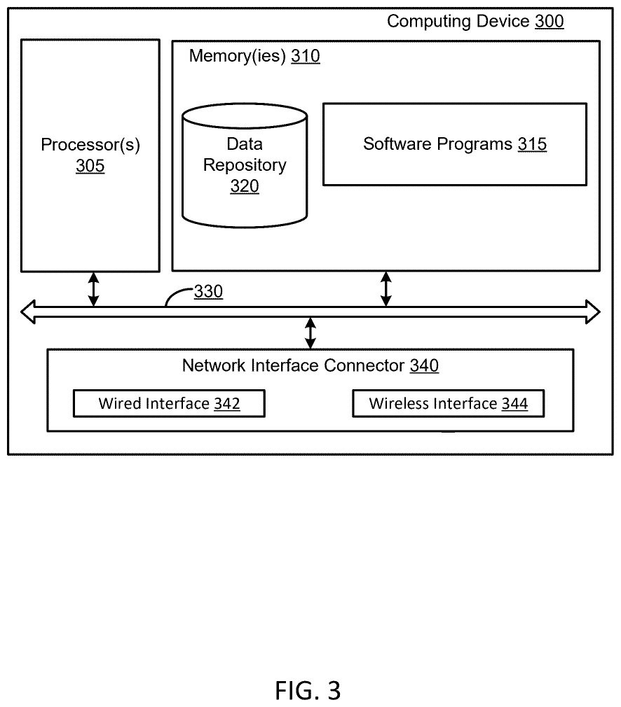

FIG. 3 depicts an exemplary computing system for implementing aspects of the present disclosure. FIG. e3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In an embodiment, the processing machine may be a specialized processor.

In an embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

What is claimed is:

1. A method, comprising:
receiving, by a computer program, a feature vector comprising features derived from raw user data for a user and tile data for a plurality of tiles that are available to surface in a computer application;
providing, by the computer program, the feature vector to an artificial neural network;
receiving, by the computer program and from the artificial neural network for each tile, an engagement probability parameter and an uncertainty parameter;
receiving, by the computer program, a scaling factor that influences a randomness of the tiles being surfaced;
ranking, by the computer program, the plurality of tiles using the engagement probability parameters, the uncertainty parameters, and the scaling factor; and
controlling, by the computer program, the computer application to surface the plurality of tiles based on the ranking.

2. The method of claim 1, wherein the tiles comprise blocks of information that are displayed within the computer application to promote a product or service.

3. The method of claim 1, wherein the artificial neural network comprises a multi-layer perceptron that is configured to extract the engagement probability parameter and the uncertainty parameter from the feature vector.

4. The method of claim 1, wherein tiles with limited interaction history are assigned a neutral engagement probability parameter and a high uncertainty parameter.

5. The method of claim 1, wherein higher ranked tiles are surfaced in a first viewport in the computer application.

6. A system, comprising:
an artificial neural network;
a user electronic device for user executing a computer application; and
an electronic device executing a computer program that is configured: to receive a feature vector comprising features derived from raw user data for a user and tile data for a plurality of tiles that are available to surface in the computer application; to provide the feature vector to the artificial neural network; to receive, from the artificial neural network for each tile, an engagement probability parameter and an uncertainty parameter; to receive a scaling factor that influences a randomness of the tiles being surfaced; to rank the plurality of tiles using the engagement probability parameters, the uncertainty parameters, and the scaling factor; and to control the computer application to surface the plurality of tiles based on the ranking.

7. The system of claim 6, wherein the tiles comprise blocks of information that are displayed within the computer application to promote a product or service.

8. The system of claim 6, wherein the artificial neural network comprises a multi-layer perceptron that is configured to extract the engagement probability parameter and the uncertainty parameter from the feature vector.

9. The system of claim 6, wherein tiles with limited interaction history are assigned a neutral engagement probability parameter and a high uncertainty parameter.

10. The system of claim 6, wherein higher ranked tiles are surfaced in a first viewport in the computer application.

11. A non-transitory computer readable storage medium, including instructions stored thereon, which when read and executed by one or more computer processors, cause the one or more computer processors to perform steps comprising:
receiving a feature vector comprising features derived from raw user data for a user and tile data for a plurality of tiles that are available to surface in a computer application;
providing the feature vector to an artificial neural network;
receiving, for each tile, an engagement probability parameter and an uncertainty parameter;
receiving a scaling factor that influences a randomness of the tiles being surfaced;
ranking the plurality of tiles using the engagement probability parameters, the uncertainty parameters, and the scaling factor; and
controlling the computer application to surface the plurality of tiles based on the ranking, wherein higher ranked tiles are surfaced in a first viewport in the computer application.

12. The non-transitory computer readable storage medium of claim 11, wherein the tiles comprise blocks of information that are displayed within the computer application to promote a product or service.

13. The non-transitory computer readable storage medium of claim 11, wherein the artificial neural network comprises a multi-layer perceptron that is configured to extract the engagement probability parameter and the uncertainty parameter from the feature vector.

14. The non-transitory computer readable storage medium of claim 11, wherein tiles with limited interaction history are assigned a neutral engagement probability parameter and a high uncertainty parameter.
